(19) United States
(12) Patent Application Publication
(10) Pub. No.: US 2006/0129271 A1
(43) Pub. Date: Jun. 15, 2006

(54) System, method, and article of manufacture for generating a CAD model indicating an amount of material added or removed from a part to form a feature in the part

(76) Inventors: Pravin Khurana, Rochester, MI (US); Raghunath P. Khetan, Troy, MI (US); Kevin H. Marseilles, Frankenmuth, MI (US)

Correspondence Address: DELPHI TECHNOLOGIES, INC., M/C 480-410-202, PO BOX 5052, TROY, MI, 48007, US

(21) Appl. No.: 11/301,748

(22) Filed: Dec. 13, 2005

Related U.S. Application Data
(60) Provisional application No. 60/635,872, filed on Dec. 14, 2004.

(51) Int. Cl. G06F 19/00

(52) U.S. Cl. 700/182; 700/98; 700/118

(57) ABSTRACT

A system, method, and article of manufacture for generating a CAD model indicating an amount of material added or removed from a part to form a feature in the part are provided. The method includes generating a first CAD model of the part. The method further includes generating a second CAD model of the part having at least one additional feature not present in the first CAD model. The method further includes generating a third CAD model based on the first and second CAD models indicating the amount of material either added or removed from the first CAD model to form the at least one additional feature in the second CAD model.

### CROSS REFERENCE TO RELATED APPLICATION

The application claims the benefit of U.S. Provisional application Ser. No. 60/635,872, filed Dec. 14, 2004, the contents of which are incorporated herein by reference thereto.

### TECHNICAL FIELD

This application relates to a system, method, and article of manufacture for generating a CAD model indicating an amount of material added or removed from a part to form a feature in the part.

### BACKGROUND

Computer aided design (CAD) systems have been developed that allow an engineer to generate CAD models of parts. Generally, an engineer can utilize a CAD system to add or remove features from the CAD models. For example, a feature can comprise a slot, a hole, or a groove. CAD systems, however, do not allow engineers to visualize the amount of material removed or added to a CAD model to form each feature. As result, engineers have a relatively difficult time determining a manufacturing process sequence for forming the feature in the part when they cannot visualize the amount of material being removed or added to the part.

Accordingly, there is a need for a system and a method of generating a CAD model that is indicative of the amount of material added or removed from a part to form a feature in the part.

### SUMMARY

A method for generating a CAD model indicating an amount of material added or removed from a part to form a feature in the part in accordance with an exemplary embodiment is provided. The method includes generating a first CAD model of the part. The method further includes generating a second CAD model of the part having at least one additional feature not present in the first CAD model. The method further includes generating a third CAD model based on the first and second CAD models indicating the amount of material either added or removed from the first CAD model to form the at least one additional feature in the second CAD model.

A system for generating a CAD model indicating an amount of material added or removed from a part to form a feature in the part in accordance with another exemplary embodiment is provided. The system includes a computer configured to generate a first CAD model of the part. The computer is further configured to generate a second CAD model of the part having at least one additional feature not present in the first CAD model. The computer is further configured to generate a third CAD model based on the first and second CAD models indicating the amount of material either added or removed from the first CAD model to form the at least one additional feature in the second CAD model.

An article of manufacture in accordance with another exemplary embodiment is provided. The article of manufacture includes a computer storage medium having a computer program encoded therein for generating a CAD model indicating an amount of material added or removed from a part to form a feature in the part. The computer storage medium includes code for generating a first CAD model of the part. The computer storage medium further includes code for generating a second CAD model of the part, the second CAD model having at least one additional feature not present in the first CAD model. The computer storage medium further includes code for generating a third CAD model based on the first and second CAD models indicating the amount of material either added or removed from the first CAD model to form the at least one additional feature in the second CAD model.

### BRIEF DESCRIPTION OF THE DRAWINGS

FIG. 1 is a schematic of a system for generating a CAD model indicating an amount of material added or removed from a part to form a feature in the part;

FIG. 2 is a schematic of a master CAD model having first, second, third, and fourth CAD models of the part stored therein;

FIG. 3 is a schematic of a fifth CAD model indicating an amount of material removed from the first CAD model to form the first feature in the second CAD model;

FIG. 4 is a schematic of a sixth CAD model indicating an amount of material removed from the second CAD model to form the second feature in the third CAD model;

FIG. 5 is a schematic of a seventh CAD model indicating an amount of material removed from the third CAD model to form the third feature in the fourth CAD model;

FIG. 6 is a schematic of an eighth CAD model indicating an amount of material removed from the fourth CAD model to form the fourth feature in the master CAD model; and

FIGS. 7 and 8 are flowcharts of a method for generating a CAD model indicating an amount of material added or removed from a part to form a feature in the part.

### DESCRIPTION OF EXEMPLARY EMBODIMENTS

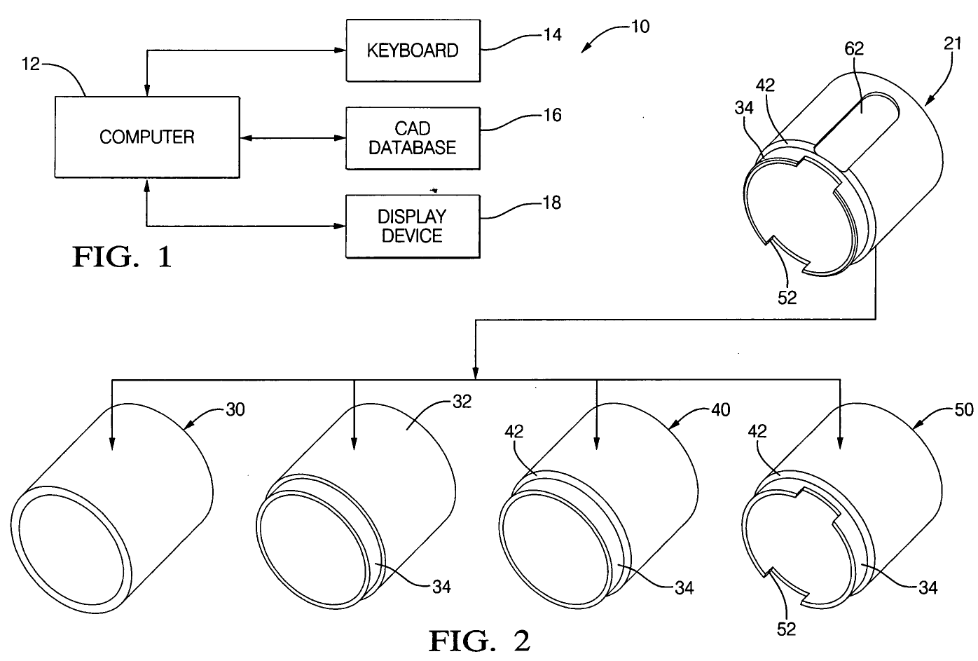

Referring to FIG. 1, a system 10 for generating a CAD model indicating an amount of material added or removed from a part to form a feature in the part is illustrated. In particular, the system 10 utilizes feature-based computer aided design (CAD) models of a part for generating a 3-D CAD model indicating the material added or removed from the part to form the feature in the part. The CAD models include feature attributes, hereinafter referred to as “features”, corresponding to the physical features of the part. Each feature includes feature parameter data associated therewith for defining the feature including a feature name and dimensional data. For example, the master CAD model 60 includes a feature 34 having the OD_GROOVE feature name, a feature 42 having the OD_CHAMFER feature name, a feature 52 having the RADIAL_SLOT feature name, and a feature 62 having the AXIAL_SLOT feature name. The system 10 includes a computer 12, a keyboard 14, a CAD database 16, and a display device 18.

The computer 12 is provided to assist an operator in generating the CAD models of the part. The computer 12 has a CAD software program executing thereon. The CAD program can comprise any program capable of generating feature-based CAD models. The computer 12 is further operably coupled to the display device 18 for displaying the CAD models of the part. The computer 12 is further operably coupled to the CAD database 16 for storing the CAD models therein and retrieving the CAD models therefrom.

The keyboard 14 is provided to allow a user to input information for generating and retrieving CAD models. The keyboard 14 is operably coupled to the computer 12.

The display device 18 is provided to display CAD models of one or more parts. The display device 18 is operably coupled to the computer 12.

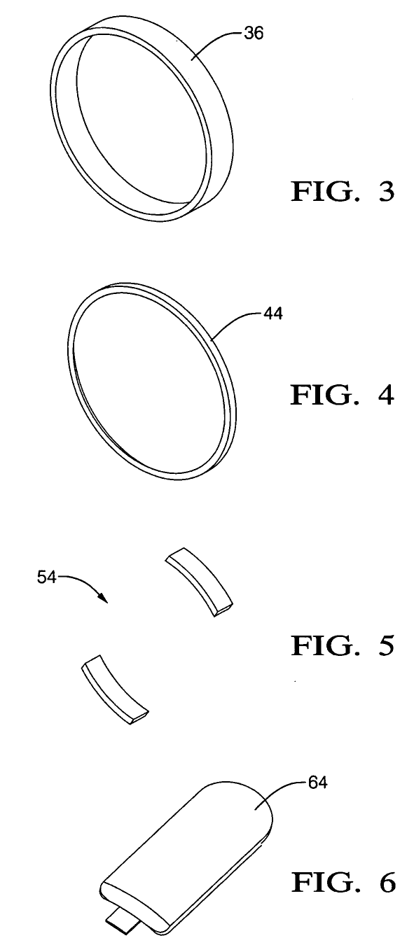

Referring to FIGS. 7-8 and 2-6, a method for generating a CAD model indicating an amount of material added or removed from a part to form a plurality of features in the part will now be explained. The method can be implemented in a software algorithm utilizing the system 10 described above. As discussed below, each of the CAD models 30, 32, 40, 50 are stored in the master CAD model 21 in the CAD database 16. In an alternative embodiment, each of the CAD models are stored in separate distinct CAD files in the CAD database 16.

At step 80, an operator generates the master CAD model 21 of a part using the computer 12.

At step 82, the computer 12 generates a CAD model 30 of the part using the master CAD model 21. In particular, the computer 12 extracts of the CAD model 30 from the master CAD model 21 using a method known by those skilled in the art. Further, the computer 12 displays the CAD model 30 on the display device 18 and stores the CAD model 30 in the CAD database 16.

At step 84, the computer 12 generates a CAD model 32 using the master CAD model 21. The CAD model 32 has a feature 34 with an OD_GROOVE feature name not present in the CAD model 30. The computer 12 generates the CAD model 32 by extracting the CAD model 32 from the master CAD model 21 using a method known by those skilled in the art. Further, the computer 12 displays the CAD model 32 on the display device 18 and stores the CAD model 32 in the CAD database 16

At step 86, the computer 12 generates the CAD model 40 using the master CAD model 21. The CAD model 40 has a feature 42 with an OD_CHAMFER feature name not present in the CAD model 32. The computer 12 generates the CAD model 40 by extracting the CAD model 40 from the master CAD model 21 using a method known by those skilled in the art. Further, the computer 12 displays the CAD model 40 on the display device 18 and stores the CAD model 40 in the CAD database 16.

At step 88, the computer 12 generates the CAD model 50 using the master CAD model 21. The CAD model 50 has a feature 52 with a RADIAL_SLOT feature name not present in the CAD model 40. The computer 12 generates the CAD model 50 by extracting the CAD model 50 from the master CAD model 21 using a method known by those skilled in the art. Further, the computer 12 displays the CAD model 50 on the display device 18 and stores the CAD model 50 in the CAD database 16.

At step 90, the computer 12 generates a CAD model 36 based on the CAD models 30, 32 indicating the amount of material removed from the CAD model 30 to form the feature 34 having the OD_GROOVE feature name in the CAD model 32. In particular, the CAD model 36 is obtained by performing a Boolean subtraction of the CAD model 30 from the CAD model 32. Further, the computer 12 displays the CAD model 36 on the display device 18 and stores the CAD model 36 in the CAD database 16.

At step 92, the computer 12 generates a CAD model 44 based on the CAD models 32, 40 indicating the amount of material removed from the CAD model 32 to form the feature 42 having the OD_CHAMFER feature name in the CAD model 40. In particular, the CAD model 44 is obtained by performing a Boolean subtraction of the CAD model 32 from the CAD model 40. Further, the computer 12 displays the CAD model 44 on the display device 18 and stores the CAD model 44 in the CAD database 16.

At step 94, the computer 12 generates a CAD model 54 based on the CAD models 40, 50 indicating the amount of material removed from the CAD model 40 to form the feature 52 having the RADIAL_SLOT feature name in the CAD model 50. In particular, the CAD model 54 is obtained by performing a Boolean subtraction of the CAD model 40 from the CAD model 50. Further, the computer 12 displays the CAD model 54 on the display device 18 and stores the CAD model 54 in the CAD database 16.

At step 96, the computer 12 generates a CAD model 64 based on the CAD model 50 and the master CAD model 21 indicating the amount of material removed from the CAD model 50 to form the feature 62 having the AXIAL_SLOT feature name in the master CAD model 21. In particular, the CAD model 64 is obtained by performing a Boolean subtraction of the CAD model 50 from the master CAD model 21. Further, the computer 12 displays the CAD model 64 on the display device 18 and stores the CAD model 64 in the CAD database 16. After step 96, the method is exited.

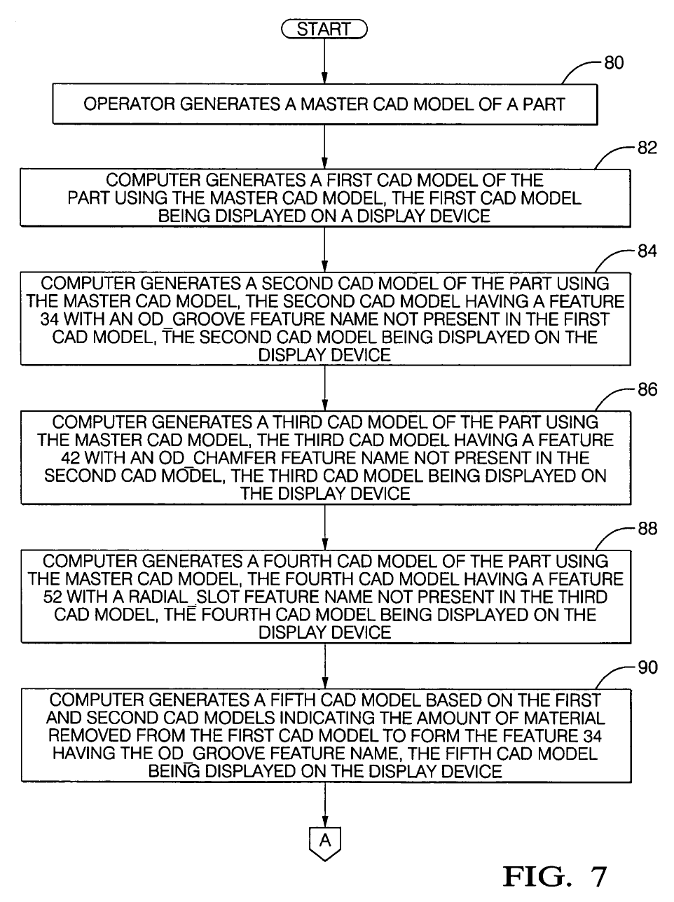

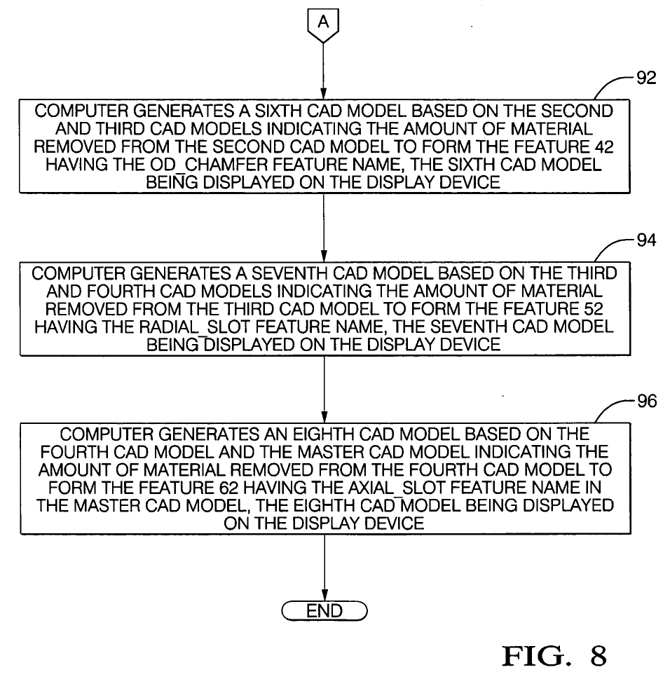

It should be noted that although the flowchart in FIGS. 7 and 8 depict a method utilizing material removal features, the method could alternately be utilized for material added features. For example, a boss is considered a feature where a cylindrical protrusion is added to a specific part. In this example, the method would include generating a first CAD model of the part. A second CAD model of the part is then generated having the boss feature not present in the first CAD model. A third CAD model is then generated based on the first and second CAD models indicating the amount of material added to the first CAD model to form the boss feature in the second CAD model. The third CAD model is generated by performing a Boolean subtraction of the first CAD model from the second CAD model to obtain the third CAD model.

The computer-readable storage medium accessed by the computer 12 will store a series of computer-executable instructions which will implement the above-described method. The computer-readable storage medium can comprise any device capable of storing computer executable instructions. For example, the computer readable storage medium can comprise a RAM or ROM of the computer, a computer diskette, a CD ROM, a flash memory device, a magnetic tape, a conventional hard disk drive, and an optical storage device, or the like.

The above described system, method, and article of manufacture for generating a CAD model provides a substantial advantage over other systems and methods. In particular, the system, method, and article of manufacture provides a technical effect generating a CAD model indicating the amount of material either added or removed from a part to form the feature in the part enabling an engineer to visualize the amount of material added or removed during a manufacturing process.

What is claimed is:

1. A method for generating a CAD model indicating an amount of material added or removed from a part to form a feature in the part, comprising:
generating a first CAD model of the part;
generating a second CAD model of the part, the second CAD model having at least one additional feature not present in the first CAD model; and
generating a third CAD model based on the first and second CAD models indicating the amount of material either added or removed from the first CAD model to form the at least one additional feature in the second CAD model.

2. The method of claim 1, wherein the step of generating the third CAD model comprises performing a Boolean subtraction of the second CAD model from the first CAD model to obtain the third CAD model.

3. The method of claim 1, wherein the step of generating the third CAD model comprises performing a Boolean subtraction of the first CAD model from the second CAD model to obtain the third CAD model.

4. The method of claim 1, wherein the first CAD model and the second CAD model are stored in a master CAD model.

5. The method of claim 4, wherein the third CAD model is stored in the master CAD model.

6. A system for generating a CAD model indicating an amount of material added or removed from a part to form a feature in the part, comprising:
a computer configured to generate a first CAD model of the part, the computer further configured to generate a second CAD model of the part, the second CAD model having at least one additional feature not present in the first CAD model, the computer further configured to generate a third CAD model based on the first and second CAD models indicating the amount of material either added or removed from the first CAD model to form the at least one additional feature in the second CAD model.

7. The system of claim 6, wherein the computer is configured to generate the third CAD model by performing a Boolean subtraction of the second CAD model from the first CAD model.

8. The system of claim 6, wherein the computer is configured to generate the third CAD model by performing a Boolean subtraction of the first CAD model from the second CAD model.

9. The system of claim 6, wherein the first CAD model and the second CAD model are stored in a master CAD model.

10. The system of claim 9, wherein the third CAD model is stored in the master CAD model.

11. An article of manufacture, comprising:
a computer storage medium having a computer program encoded therein for generating a CAD model indicating an amount of material added or removed from a part to form a feature in the part, the computer storage medium comprising:
code for generating a first CAD model of the part;
code for generating a second CAD model of the part, the second CAD model having at least one additional feature not present in the first CAD model; and
code for generating a third CAD model based on the first and second CAD models indicating the amount of material either added or removed from the first CAD model to form the at least one additional feature in the second CAD model.

12. The article of manufacture of claim 11, wherein the code for generating the third CAD model comprises code for performing a Boolean subtraction of the second CAD model from the first CAD model to obtain the third CAD model.

13. The article of manufacture of claim 11, wherein the code for generating the third CAD model comprises code for performing a Boolean subtraction of the first CAD model from the second CAD model to obtain the third CAD model.

14. The article of manufacture of claim 11, wherein the first CAD model and the second CAD model are stored in a master CAD model.

15. The article of manufacture of claim 14, wherein the third CAD model is stored in the master CAD model.
